(19) United States
(12) Patent Application Publication
(10) Pub. No.: US 2012/0228362 A1
(43) Pub. Date: Sep. 13, 2012

(54) PROCESS FOR OPERATING A STRINGER AND STRINGER APPARATUS

(75) Inventors: Martin Schultis, Waldkirch (DE); Bernd Hirzler, Endingen (DE)

(73) Assignee: SOMONT GMBH, Umkirch (DE)

(21) Appl. No.: 13/421,647

(22) Filed: Mar. 15, 2012

Related U.S. Application Data
(63) Continuation-in-part of application No. PCT/IB2010/054147, filed on Sep. 14, 2010.

(30) Foreign Application Priority Data
Sep. 16, 2009 (EP) 09011798

(51) Int. Cl. B23K 31/12; B23K 1/20

(52) U.S. Cl. 228/102; 228/103; 228/13; 228/8

(57) ABSTRACT

A process for operating a stringer (10) for connecting solar cells in series by solder ribbon cut-offs cut from continuous solder ribbon strip, includes monitoring depletion of the momentarily-employed continuous solder ribbon strip (13a) by a monitoring unit (16) detecting when the end (17) of this strip (13a) approaches, entering a new roll (2) with a new continuous solder ribbon strip (13b), connecting the end (17) of the momentarily-employed strip (13a) to this new strip (13b) thereby forming a composite continuous solder ribbon strip that includes a connection, moving this composite strip to a cutting station (14), cutting this composite strip into solder ribbon cut-offs in cutting station (14), and removing the ribbon cut-off that includes this connection. Also, stringer apparatus for performing such process.

This application is a Continuation-In-Part (CIP) of copending PCT International application no. PCT/IB2010/054147 filed on Sep. 14, 2010 and published as WO2011/033452A1 on Mar. 24, 2011, which in turn claims benefit of priority to prior European application EP 09011798 filed on Sep. 16, 2009; the entirety of parent PCT International application no. PCT/IB2010/54147 is hereby expressly incorporated herein by reference, in its entirety and as to all its parts, for all intents and purposes, as if set forth identically in full herein.

The invention relates to a method for operating a stringer and to a stringer apparatus.

In order to manufacture solar modules that may, for example, be placed on a roof of a building for solar energy generation, several solar cells with bus bars are typically connected in series with each other to form so-called strings. For this, the bus bars of the solar cells are typically connected with the bus bars of neighboring solar cells by solder ribbons or solder ribbon cut-offs, respectively. The solder ribbons are typically made of tinned copper and are connected with the bus bars by one or more soldering units. A solar cell may have several bus bars, in particular between one to three bus bars, which arrangement requires an equal amount of solder ribbon cut-offs for forming a string. The strings are formed in an apparatus called stringer.

After the solar cell strings have been formed, they are typically transferred to a quality testing station for inspection of the alignment of the solar cells and the solder ribbons, as well as for the detection of possible breakage. Then the strings are placed next to each other and cross-linked to obtain a solar cell matrix. The solar cell matrix is then laid sun-side down upon a glass plate with an adhesive layer and covered with a glass or plastics cover with an adhesive layer. Then the matrix is laminated in a laminator for protection purposes.

A stringer for forming a string from solar cells typically includes feeding station or stations for supplying solar cells and a continuous solder ribbon strip. The continuous solder ribbon strip is usually uncoiled from a roll that is mounted in a feeding station. For each bus bar of a solar cell there is provided one roll with a continuous solder ribbon strip. After uncoiling, the continuous solder ribbon strip is transferred to a cutting station where it is cut into discrete solder ribbon cut-offs whose length is approximately twice the length of a solar cell, so that two neighboring solar cells may be connected with one or more parallel solder ribbons depending on the number of bus bars that the solar cell has. The solar cells and the cut solder ribbons (solder ribbon cut-offs) are connected in a soldering station to form the strings which are then aligned and tested for possible breakage.

In general, the length of a continuous solder ribbon strip that is coiled up on a roll is not known exactly. Typically, length values are in the range of two kilometers. When an employed roll of continuous solder ribbon strip is depleted/runs-out, its end is typically connected by soldering to the free end of a new continuous solder ribbon strip of a new roll that has been entered into the feeding station, thereby forming a composite or combined continuous solder ribbon strip having a connection point or region. At this connection location, the currently-employed and the new continuous solder ribbon strip have been connected by soldering. Considering that the composite continuous solder ribbon strip is typically thicker at the connection, the part of the composite continuous solder ribbon strip that comprises the connection cannot be used for connecting the solar cells. The composite continuous solder ribbon strip is therefore usually drawn by grippers through the stringer until it reaches an exit in the longitudinal direction where the composite continuous solder ribbon strip is cut after the connection has passed the exit. However, due to the typical length of a stringer a relatively large amount of the continuous solder ribbon strip is lost thereby. For existing stringers approximately six meters of the continuous solar ribbon strip are lost per roll in so doing.

The invention relates to the context of providing a process for operating a stringer by which the productive utilization of the continuous solder ribbon strip(s) may be improved. In aspects, the invention provides a process for operating a stringer by which an employed continuous solder ribbon strip that runs out may be connected to a new continuous solder ribbon strip in a time-saving manner. In further aspects, the invention relates to the context of providing a process for operating a stringer by which an employed continuous solder ribbon strip that runs out may be connected to a new continuous solder ribbon strip during running operation of the stringer. Versions of the invention also provide a stringer for performing the associated process.

In order to seek these or still further advantages by implementations of the invention, as shall become more readily apparent as the description proceeds, a process for operating a stringer is provided in which depletion of the currently/momentarily-employed continuous solder ribbon strip may monitored by a monitoring unit. Depletion may be detected by the monitoring unit when the end of the momentarily-employed continuous solder ribbon strip approaches a connecting station. A new roll with a new continuous solder ribbon strip may be entered into a feeding station, and the end of the momentarily-employed continuous solder ribbon strip may be connected to the new continuous solder ribbon strip, in particular to the free end of the new continuous solder ribbon strip, within the connecting station thereby forming a composite or jointed continuous solder ribbon strip having a connection. The composite continuous solder ribbon strip is incrementally, step-by-step, as under clock cycle control, moved to a cutting station. The composite continuous solder ribbon strip is cut into single/discrete solder ribbon cut-offs (also called ‘solder ribbons’) in the cutting station, and the single/discrete solder ribbon cut-off that includes the connection is removed. The connecting station does not necessarily need to be a separate physical unit, but may be any location in the production line at which the connection of the momentarily-employed continuous solder ribbon strip to the new continuous solder ribbon strip takes place.

In the following description, the term “solder ribbon cut-off” is, for simplicity, employed instead of “single/discrete solder ribbon cut-off”. The connection of the composite continuous solder ribbon strip is that point, region, or location at which the end of the momentarily-employed continuous solder ribbon strip is connected or joined with the new continuous solder ribbon strip or its free end, respectively.

For forming the composite continuous solder ribbon strip, the end of the momentarily-employed continuous solder ribbon strip may be joined or connected to the new continuous solder ribbon strip (in particular its free end) for example by soldering; welding such as, e.g., cold pressure welding; gluing (in particular by conducting adhesive); processes for forming compression joints such as, e.g., cold pressing, warm pressing or hot pressing; forming a crimp connection; riveting (also cold riveting); splicing; and/or by any other apt way for forming an appropriate connection, with the connecting station being configured accordingly.

The stringer apparatus may include a feeding station for supplying a continuous solder ribbon strip, in which in particular a roll of a continuous solder ribbon strip is uncoiled in operation. Furthermore, the stringer apparatus may include a cutting station configured to cut the continuous solder ribbon strip into solder ribbon cut-offs, a monitoring unit configured to monitor depletion of the momentarily-employed continuous solder ribbon strip, a connecting station configured to connect the end of the momentarily-employed continuous solder ribbon strip to the new continuous solder ribbon strip by soldering to form a composite continuous solder ribbon strip having a connection, and a remover configured to remove a solder ribbon cut-off that includes this connection. The removers for the solder ribbon cut-off(s) that contain the connection are preferably configured as grippers, in particular as those grippers that are already provided in the stringer for transporting of the solder ribbon cut-offs from the cutting station towards the soldering station.

The entering of a new roll having a new continuous solder ribbon strip may take place manually, but may also take place automatically if an automatically-fed feeding station is provided. Moving of the composite continuous solder ribbon strip after it has been formed in the connecting station may either be initiated manually, e.g., by a staff member pressing a corresponding button on the stringer (also called half-automatic operation), or automatically when, e.g., the monitoring unit automatically detects that the connection is completed (also called fully automatic operation). If the connection of the end of the momentarily-employed continuous solder ribbon strip and the new continuous solder ribbon strip takes place during running operation, then no additional initiation of the moving is required. The composite continuous solder ribbon strip is then automatically moved with the next operating step (also called fully automatic operation).

The connecting station comprises preferably a holder for the ends of the momentarily-employed continuous solder ribbon strip and the new continuous solder ribbon strip that shall be connected, as well as a soldering unit with a soldering tip for connecting these ends.

The process and the stringer apparatus according to versions of the invention have an advantage that, the part (or segment) of the composite continuous solder ribbon strip that includes the connection may be easily removed in a time-saving manner, with relatively little waste of the composite continuous solder ribbon strip material.

In a preferred version of the invention, a surveillance unit is provided downstream the cutting station for monitoring the cut solder ribbon cut-offs to detect solder ribbon cut-offs that include a connection. The cutting station preferentially contains a camera, in particular a three-dimensional camera. The detected solder ribbon cut-offs that include a connection are then removed by the remover. A control unit may be configured to control the remover in dependence on a signal, for example an output signal, of the surveillance unit.

In a further preferred version of the invention a control unit is provided, wherein the number of production steps from the connecting station to the cutting station is known and stored in the control unit. After the composite continuous solder ribbon strip has been formed in the connecting station and has been moved by the number of production steps from the connecting station to the cutting station plus by one additional step, then that solder ribbon cut-off that includes the connection has just been cut off the composite continuous solder ribbon strip by the cutting station, and the remover is controlled by the control unit so that this particular segment of solder ribbon cut-off is removed.

In a further preferred version of the invention a control unit is provided, wherein the distance from the connecting station to the cutting station is known and stored in the control unit. After the composite continuous solder ribbon strip has been formed in the connecting station and has been moved by the known distance from the connecting station to the cutting station, then that part of the composite solder ribbon strip that includes the connection will be cut next by the cutting station. Then the remover is controlled by the control unit so that the solder ribbon cut-off that is cut next is removed after it has been cut.

The monitoring unit is preferably configured to trigger an alarm when the monitoring unit detects that the end of the momentarily-employed continuous solder ribbon strip is approaching. The alarm is preferably triggered a certain predefined amount of time, e.g. five minutes, before the end of the momentarily-employed continuous solder ribbon strip enters the connecting station. Triggering the alarm a certain amount of time before the momentarily-employed continuous solder ribbon strip reaches end advantageously leaves the operating staff enough time to insert a new roll with a new continuous solder ribbon strip into the feeding station, so that connection of the end of the momentarily-employed continuous solder ribbon strip with the new continuous solder ribbon strip can take place during running operation without need for stopping the operation of the stringer (fully automatic operation).

The above described preferred versions may be employed separately or in all possible combinations with each other.

Further advantageous features and applications of versions of the invention shall become evident from the remaining disclosure, the following description of the drawings, and the drawing figures. In the drawings like reference signs designate the same or similar parts throughout the several figures, in which:

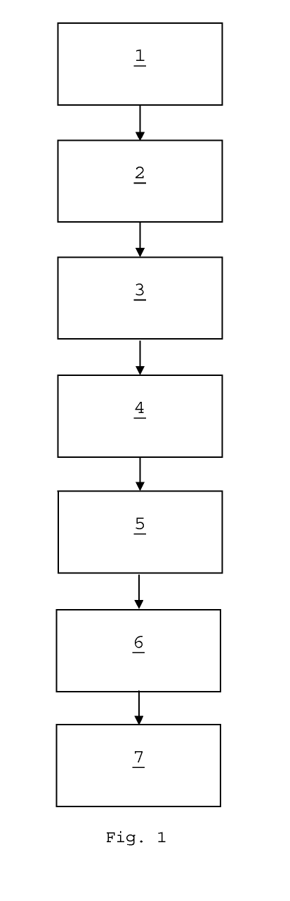

FIG. 1 shows a flow chart of the method according to the invention; and,

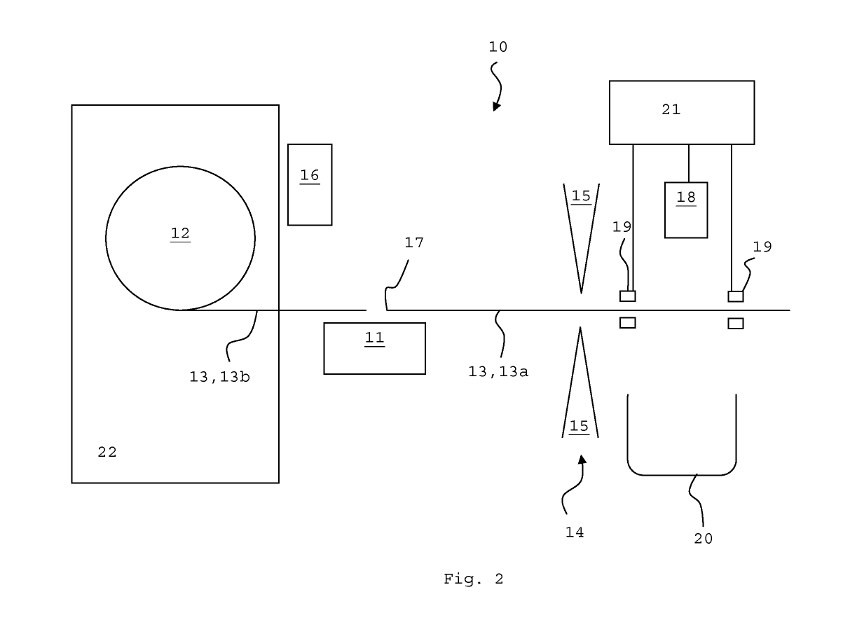

FIG. 2 schematically depicts a partial side view of a stringer assembly according to the invention.

FIG. 1 shows a flow chart of the method of the invention. FIG. 2 schematically depicts part of a stringer 10 for performing the method of the invention. Soldering station for connecting the solder ribbon cut-offs with the solar cells and testing stations are not shown, for simplicity. The stringer 10 comprises a feeding station 22 that is fed with a roll 12 onto which a continuous solder ribbon strip 13 is coiled. The continuous solder ribbon strip 13 is uncoiled from the roll 12 and drawn via a connecting station 11 to a cutting station 14 with cutters 15 for cutting the continuous solder ribbon strip 13 into solder ribbon cut-offs. FIG. 2 depicts the continuous solder ribbon strip 13 being drawn beyond the cutting station 14 before a solder ribbon cut-off has been cut from it by the cutters 15.

The depletion of the currently-employed continuous solder ribbon strip 13a is monitored by a monitoring unit 16 in step 1 of the method of the invention. When the monitoring unit 16 in step 2 of the method of the invention detects that the end 17 of the momentarily-employed continuous solder ribbon strip 13a approaches the connecting station 11, it preferably triggers an alarm a certain predefined amount of time before the currently-employed solder ribbon strip 13a actually enters the connecting station 11, so as to inform the operating staff that a new roll 2 with a new continuous solder ribbon strip 13b has to be inserted into the feeding station 22. After a new roll 12 has been entered into the feeding station 22 in step 3, the new continuous solder ribbon strip 13b is drawn by grippers (not shown) to the connecting station 11.

In the connecting station 11, the end 17 of the momentarily-employed continuous solder ribbon strip 13a is connected to the free end of the new continuous solder ribbon strip 13b by a soldering unit (not shown) to form a composite continuous solder ribbon strip that includes the connection (step 4) where two solder ribbon strips 13a, 13b have been joined. In step 5 the composite continuous solder ribbon strip is stretched and moved, in particular incrementally as under clock cycle control, by grippers (not shown) to the cutting station 14. This move may be initiated manually or automatically as described above, or it may occur within a normal operating step during running operation.

The cutters 15 of the cutting station 14 cut a solder ribbon cut-off, as a segment, from the composite continuous solder ribbon strip in step 6. In the direction of movement after the cutters 15 there is preferably provided a surveillance unit 18 in form of a camera configured to monitor the cut solder ribbon cut-offs for the presence of a connection. When the surveillance unit 18 detects such a connection in a solder ribbon cut-off, it sends a corresponding signal to a control unit 21. The control unit 21 then sends a control signal to the grippers 19 that hold that particular solder ribbon cut-off after it left the cutting station 14 to control the grippers 19 so that they, in step 7 of the process, remove the solder ribbon cut-off containing the connection from the flow of solder ribbon cut-offs and dispose that solder ribbon cut-off in a waste container 20. From the waste container 20 the disposed solder ribbon cut-offs are preferably transferred to a discharging unit (not shown) that is preferentially located outside the stringer 10.

In closing, it should be noted that the invention is not limited to the abovementioned versions and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. A process for operating a solar cell stringer comprising the steps of:
monitoring depletion of currently-employed continuous solder ribbon strip supply with a monitoring unit;
detecting the approach of an end of the supplied currently-employed continuous solder ribbon strip;
entering a new solder ribbon strip supply roll in the supply path;
connecting the end of the currently-employed continuous solder ribbon strip to the new solder ribbon strip at a connecting station;
forming a composite continuous solder ribbon strip including a connection by said step of connecting the end of the currently-employed continuous solder ribbon strip to the new solder ribbon strip;
moving the composite continuous solder ribbon strip to a cutting station;
cutting the composite continuous solder ribbon strip into solder ribbon cut-offs in the cutting station; and,
removing a solder ribbon cut-off that contains the connection.

2. A process for operating a solar cell stringer as claimed in claim 1, further comprising the steps of:
monitoring the solder ribbon cut-offs with a surveillance unit subsequently to said step of cutting the composite continuous solder ribbon strip into solder ribbon cut-offs in the cutting station;
detecting a solder ribbon cut-off containing a connection with said surveillance unit by said step of monitoring the solder ribbon cut-offs with a surveillance unit; and,
executing said step of removing a solder ribbon cut-off that contains the connection based on said step of detecting a solder ribbon cut-off containing a connection with said surveillance unit.

3. A process for operating a solar cell stringer as claimed in claim 1, further comprising the steps of:
storing in a control unit the number of production steps from the connecting station to the cutting station;
forming and moving the composite continuous solder ribbon strip within the stored number of production steps from the connecting station to the cutting station; and,
executing one additional production step before said step of removing a solder ribbon cut-off that contains the connection.

4. A process for operating a solar cell stringer as claimed in claim 1, further comprising the steps of:
storing in a control unit the distance from the connecting station to the cutting station;
forming and moving the composite continuous solder ribbon strip by the distance from the connecting station to the cutting station; and,
removing the next solder ribbon cut-off after said step of forming and moving the composite continuous solder ribbon strip by the distance from the connecting station to the cutting station.

5. A process for operating a solar cell stringer as claimed in claim 1, further comprising the step of:
triggering an alarm by the monitoring unit after said step of detecting the approach of an end of the supplied currently-employed continuous solder ribbon strip.

6. A process for operating a solar cell stringer as claimed in claim 5, further comprising the step of:
providing a predetermined time interval before the end of the supplied currently-employed continuous solder ribbon strip enters the connecting station; and,
executing at a beginning of said time interval said step of triggering an alarm.

7. A solar cell stringer comprising:
a feeding station configured to supply a continuous solder ribbon strip;
a monitoring unit configured to monitor depletion of supplied continuous solder ribbon strip;
a connecting station configured to form a connection of a solder ribbon strip end, of the continuous solder ribbon strip supplied by said supply arrangement, to a new continuous solder ribbon strip;
a cutting station configured to cut continuous solder ribbon strip into solder ribbon cut-offs; and,
at least one remover configured to remove a cut solder ribbon cut-off that contains a connection formed by said connecting station.

8. A solar cell stringer as claimed in claim 7 further comprising:
at least one gripper in said remover.

9. A solar cell stringer as claimed in claim 8 further comprising:
a plurality of grippers in said remover.

10. A solar cell stringer as claimed in claim 7 further comprising:
a waste container configured to receive a solder ribbon cut-off removed by said remover.

11. A solar cell stringer as claimed in claim 7 further comprising:
an alarm operatively connected to said monitoring unit to signal an alarm when said monitoring unit detects approach of an end of the supplied continuous solder ribbon strip.

12. The solar cell stringer as claimed in claim 11 wherein:
said alarm being operatively connected to said monitoring unit to signal an alarm at a predetermined time interval prior to entry of an end of the supplied continuous solder ribbon strip into said connecting station.

13. A solar cell stringer as claimed in claim 7 further comprising:
a surveillance unit configured to monitor solder ribbon cut-offs for presence of connections formed by said connecting unit.

14. A solar cell stringer as claimed in claim 7 further comprising:
a control unit operatively connected to control said at least one remover, said control unit having a memory device configured to store the number of production steps from said connecting station to said cutting station.

15. A solar cell stringer as claimed in claim 7 further comprising:
a control unit operatively connected to control said at least one remover, said control unit having a memory device configured to store the distance from said connecting station to said cutting station.
